(19) United States
(12) Patent Application Publication
(10) Pub. No.: US 2025/0214146 A1
(43) Pub. Date: Jul. 3, 2025

(54) EFFICIENT CHATTER CUTTING METHOD FOR DIFFICULT-TO-MACHINE MATERIALS

(71) Applicant: Beihang University, Beijing (CN)

(72) Inventors: Deyuan ZHANG, Beijing (CN); Heng LIU, Beijing (CN); Wenshuai WU, Beijing (CN); Mingshuo ZHANG, Beijing (CN); Jiteng LI, Beijing (CN)

(21) Appl. No.: 18/735,752

(22) Filed: Jun. 6, 2024

(30) Foreign Application Priority Data
Dec. 29, 2023 (CN) 202311864762.1

(51) Int. Cl. B23B 27/00; B23Q 11/10

(52) U.S. Cl. CPC B23B 27/002; B23Q 11/10

(57) ABSTRACT

An efficient chatter cutting method for a difficult-to-machine material is provided, relating to the technical field of cutting processing. The method includes the following steps: installing a chatter tool bar on a machine tool, starting the machine tool, and inducing self-excited chatter for chatter cutting through cutting energy of a tool system; during chatter cutting, exciting the chatter tool bar to induce stable vibration, making the tool form a ratchet-shaped motion trajectory, the ratchet-shaped motion trajectory includes processes that the tool is pressed on a surface of a workpiece and the tool is separated from the surface of the workpiece, and forming a ratchet-shaped surface morphology on the surface of the workpiece; and during separation of the tool from the surface of the workpiece, enabling cutting fluid to enter a separated cutting zone for cooling and lubrication, and reducing cutting temperature.

### CROSS-REFERENCE TO RELATED APPLICATION

This application claims foreign priority benefits under 35 U.S.C. § 119 to Chinese Patent Application No. 202311864762.1 filed on Dec. 29, 2023, the content of which is hereby incorporated by reference in its entirety.

### TECHNICAL FIELD

The present disclosure relates to the technical field of cutting processes, in particular to an efficient chatter cutting method for difficult-to-machine materials.

### BACKGROUND

Ultrasonic vibration cutting technology is a forced excitation cutting method that applies high-frequency and micrometer-level amplitude to a blade through an external power supply and a transducer, which has the process effects of reducing cutting force, lowering cutting temperature, increasing tool life, and improving the integrity of a machined surface, and has gradually become an advanced precision machining method. However, due to the problems of low excitation power, small vibration amplitude, complex structure, and high cost, the wide application of ultrasonic vibration cutting technology is limited.

Self-excited vibration cutting technology is a self-excited chatter cutting method in which dozens of microns amplitude are induced by cutting energy of the tool system itself, which has the advantages of simple structure, high excitation power, and large vibration amplitude, and has been applied in the aspects of producing short metal fibers by efficient chatter turning, drilling deep holes by efficient chatter chip breaking, and reducing burns by efficient chatter rough grinding. However, the tool life of chatter cutting and its influence on machining efficiency have never been concerned, and the main concern is how to suppress chatter in machining occasions.

With the increasing performance requirements for aerospace equipment, superalloys and titanium alloys are widely used. However, due to large cutting force, high cutting temperature, rapid tool wear, low machining efficiency, and poor machinability, superalloys and titanium alloys have become recognized as difficult-to-machine materials. In particular, the machining allowance of difficult-to-machine material components is large, which accounts for the main part of total machining time. Therefore, how to increase the machining efficiency of difficult-to-machine materials is a technical problem to be solved urgently.

### SUMMARY

An objective of the present disclosure is to provide an efficient chatter cutting method for difficult-to-machine materials, so as to solve the problems in the prior art. During chatter cutting, a chatter tool bar is excited to induce stable vibration, a tool forms a ratchet-shaped motion trajectory to be periodically pressed on a surface of the workpiece and separated from the surface of the workpiece. When the tool is separated from the surface of the workpiece, cutting fluid is used to cool and lubricate a separated cutting zone, thus forming a ratchet-shaped surface morphology on the surface of the workpiece. Cutting temperature can be reduced, tool wear is reduced, and machining efficiency is increased.

To achieve the objective above, the present disclosure provides the following technical solution

An efficient chatter cutting method for difficult-to-machine materials includes the following steps:
installing a chatter tool bar on a machine tool, starting the machine tool, and inducing self-excited chatter for chatter cutting through cutting energy of a tool system;
during chatter cutting, exciting the chatter tool bar to induce stable vibration, making the tool form a ratchet-shaped motion trajectory, the ratchet-shaped motion trajectory includes processes that the tool is pressed on a surface of a workpiece and the tool is separated from the surface of the workpiece, and forming a ratchet-shaped surface morphology on the surface of the workpiece; and
during separation of the tool from the surface of the workpiece, enabling cutting fluid to enter a separated cutting zone for cooling and lubrication, and reducing cutting temperature.

Preferably, a process in one vibration cycle of the ratchet-shaped motion trajectory includes the following: cutting depth is gradually increased, dynamic clearance angle is continuously decreased until the clearance angle is negative, a flank surface is continuously pressed on the surface of the workpiece, cutting force is increased, and cutting heat is accumulated. Clearance angle of the tool is gradually increased, the cutting depth is increased and then decreased, the cutting force is increased and then decreased, contact area between the flank surface and the workpiece is increased and then decreased rapidly, the flank surface of the tool is gradually separated from the surface of the workpiece, the cutting fluid is sprayed into the separated cutting zone from the flank surface of the tool, and the cutting temperature is decreased rapidly.

Preferably, the chatter tool bar is designed and manufactured according to selected machining materials and cutting parameters to ensure that vibration parameters of the chatter tool bar lie within a reasonable range of the vibration parameters. The machining materials include aluminum/magnesium/copper alloy, stainless steel, titanium alloy, superalloy, high-strength steel, and composite materials. The cutting parameters include cutting linear speed, cutting depth, and feed rate. The vibration parameters include main amplitude and main frequency in a main vibration direction of chatter. The reasonable range of the vibration parameters is related to workpiece material, tool material, and cutting parameter, depending on whether the tool life is prolonged or not compared with conventional cutting.

Preferably, stiffness of the chatter tool bar is required to be weakened, and a direction in which the stiffness is weakened is perpendicular to a direction of a machined surface or along a direction of a rotation cutting speed. During cutting, dynamic changes in the cutting force excite the chatter tool bar to chatter along a direction in which the stiffness is weak, and meanwhile, the stiffness is unable to be too weak, depending on whether the tool life is prolonged or not compared with conventional cutting.

Preferably, a control method for stiffness includes changing materials of the tool bar, selecting materials with different elastic modulus as materials of the tool bar as required, and changing shape or structure of the tool bar, depending on whether the tool life is prolonged or not compared with conventional cutting.

Preferably, the ratchet-shaped surface morphology is induced by vibration in one or more directions, and trajectory equation of relative motion between the tool and the workpiece is as follows:

$$X = {A}_{2} sin ( ω t )$$

$$Y = {A}_{1} sin ( ω t + ϕ ) + v t$$

in the equation, X is a displacement perpendicular to the surface of the workpiece, Y is a displacement along a direction of cutting speed, A₁ is an amplitude along the direction of cutting speed, A₂ is an amplitude perpendicular to the surface of the workpiece, ω is a chatter frequency of the tool in the direction of cutting speed, ϕ is phase difference between vibrations in two directions, t is time, and v is cutting linear speed; a trajectory of the relative motion between the tool and the workpiece is obtained with Y as a horizontal axis and X as a vertical axis.

Preferably, a triaxial acceleration sensor is attached to a vibration part of the chatter tool bar to measure amplitudes and frequencies in multiple directions and phase difference between vibrations in multiple directions, so as to determine a vibration trajectory of the chatter tool bar and the tool. A main chatter frequency of the chatter tool bar is approaching to an inherent frequency in the main vibration direction, and an inherent mode of the chatter tool bar is analyzed and designed to regulate the chatter frequency.

Preferably, the chatter cutting includes a chatter turning method, a chatter milling method, a chatter grinding method, a chatter drilling method, a chatter reaming method, and a chatter countersinking method.

Preferably, the cutting fluid is oil-based cutting fluid, oil-based cutting mist, a water-based cutting fluid, water-based cutting mist, or liquid nitrogen, and cutting fluid pressure is determined according to requirements for machine tool conditions and process effects.

Preferably, the machine tool includes a lathe, a milling machine, a drilling machine, a grinding machine, and a machining center capable of carrying out cutting processes.

Compared with the prior art, the present disclosure achieves the following technical effects:

According to the present disclosure, during chatter cutting, a chatter tool bar is excited to induce stable vibration, a tool forms a ratchet-shaped motion trajectory to be periodically pressed on the surface of the workpiece and separated from the surface of the workpiece. When the tool is separated from the surface of the workpiece, cutting fluid is used to cool and lubricate a separated cutting zone, thus forming a ratchet-shaped surface morphology on the surface of the workpiece. The chatter of the chatter tool bar is controlled in a reasonable range of vibration parameters. Compared with conventional cutting, through the chatter cutting for difficult-to-machine materials, the tool life can be greatly prolonged, and the machining efficiency is increased. Meanwhile, the chatter tool bar is simple in structure, convenient to apply, and low in price. Therefore, the chatter cutting can become an advanced method for efficient machining of difficult-to-machine materials.

In addition, the present disclosure can achieve the following technical effects:

According to the present disclosure, commonly recognized harmful chatter during machining process can be effectively controlled and utilized, and inspiration can be obtained from the phonation of male katydids, due to periodic separation and contact, scraping teeth have excellent wear resistance, and through reasonable chatter cutting, the tool life is prolonged, and the machining efficiency is improved.

According to the present disclosure, a reasonable chatter tool bar can be designed and manufactured according to the machining parameters of different difficult-to-machine materials, and the self-excited chatter with dozens of microns amplitude can be induced by the cutting energy of the tool system itself. Compared with the conventional vibration cutting tool bar, the chatter cutting tool bar has the advantages of simple structure, convenient manufacture, no need for external excitation power supply, and low cost.

According to the present disclosure, the chatter cutting method may be applied to multiple cutting processes, such as turning, milling, drilling, reaming, grinding, and countersinking, so as to achieve efficient machining of difficult-to-machine materials.

### BRIEF DESCRIPTION OF THE DRAWINGS

To describe the technical solutions of the embodiments of the present disclosure or in the prior art more clearly, the following briefly introduces the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is morphology of a stridulatory file and a scraper of katydids;

FIG. 2 is a principle diagram of vibrations in two directions;

FIG. 3 is a schematic diagram of a chatter cutting method;

FIG. 4 is a physical diagram of morphology of a machined surface by chatter cutting;

FIG. 5 is a structural diagram of a turning chatter tool bar;

FIG. 6 is a schematic diagram of a vibration measurement system;

FIG. 7 is a comparison diagram of triaxial amplitude measurement results;

FIG. 8 is a measurement diagram of changes in chatter frequency during chatter cutting;

FIG. 9 is a principle diagram of chatter turning of an outer circle;

FIG. 10 is a principle diagram of chatter turning of an end face;

FIG. 11 is a principle diagram of chatter turning of an inner hole;

FIG. 12 is vibration measurement of a tool bar with a cutting linear speed of 30 m/min;

FIG. 13 is vibration measurement of a tool bar with a cutting linear speed of 40 m/min;

FIG. 14 is vibration measurement of a tool bar with a cutting linear speed of 45 m/min;

FIG. 15 is vibration measurement of a tool bar with a cutting linear speed of 50 m/min;

FIG. 16 is vibration measurement of a tool bar with a cutting linear speed of 60 m/min;

FIG. 17 is a comparison diagram of tool wear between chatter cutting and conventional cutting at a speed of 30 m/min;

FIG. 18 is a comparison diagram of tool wear between chatter cutting and conventional cutting at a speed of 40 m/min;

FIG. 19 is a comparison diagram of tool wear between chatter cutting and conventional cutting at a speed of 45 m/min;

FIG. 20 is a comparison diagram of tool wear between chatter cutting and conventional cutting at a speed of 50 m/min;

FIG. 21 is a comparison diagram of tool wear between chatter cutting and conventional cutting at a speed of 60 m/min;

FIG. 22 is a comparison diagram of surface roughness between chatter cutting and conventional cutting at a speed of 30 m/min;

FIG. 23 is a comparison diagram of surface roughness between chatter cutting and conventional cutting at a speed of 40 m/min;

FIG. 24 is a comparison diagram of surface roughness between chatter cutting and conventional cutting at a speed of 45 m/min;

FIG. 25 is a schematic diagram of chatter milling on a side surface;

FIG. 26 is a schematic diagram of chatter plunge milling on a fillet;

FIG. 27 is a schematic diagram of chatter grinding;

FIG. 28 is a schematic diagram of chatter drilling;

FIG. 29 is a schematic diagram of chatter reaming;

FIG. 30 is a schematic diagram of chatter countersinking.

In the drawings: 1—clamping part; 2—overhanging part; 3—installation surface; 4—tool groove; 5—threaded hole; 6—blade; 7—workpiece; 8—milling cutter; 9—grinding head; 11—drill bit; 11—reaming bar; 12—countersink bit.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

An objective of the present disclosure is to provide an efficient chatter cutting method for difficult-to-machine materials, so as to solve the problems in the prior art. During chatter cutting, a chatter tool bar is excited to induce a stable vibration, a tool forms a ratchet-shaped motion trajectory to be periodically pressed on a surface of the workpiece and separated from the surface of the workpiece. When the tool is separated from the surface of the workpiece, cutting fluid is used to cool and lubricate a separated cutting zone, thus forming a ratchet-shaped surface morphology on the surface of the workpiece. Cutting temperature can be reduced, the tool wear is reduced, and the machining efficiency is increased.

In order to make the objectives, technical solutions and advantages of the present disclosure more clearly, the present disclosure is further described in detail below with reference to the embodiments.

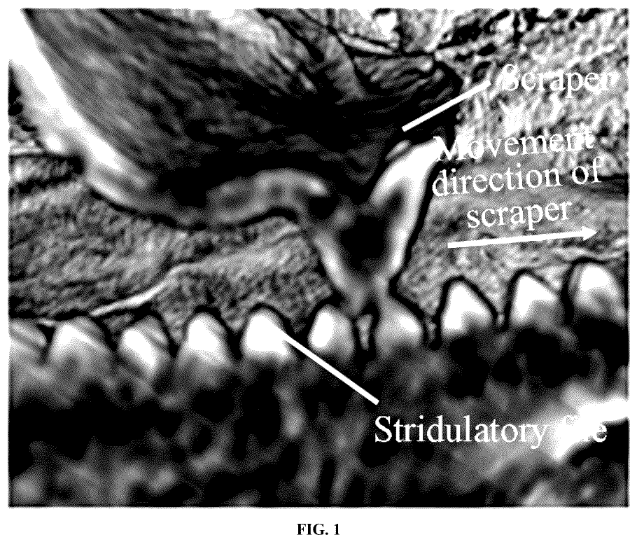

The proposal of the present disclosure is based on the bionic inspiration of katydids: the katydids refer to a family of tettigoniidae, commonly known as grasshopper. The wings of male katydids are left-over-right wings, that is, the left wing overlaps the right wing, and the left wing and the right wing are quite different in the shape. As shown in FIG. 1, a dark area on the ventral surface of the left wing is a ridged like band, which is called the stridulatory file, and there is a vein-like tissue on a edge of a back of the right wing, which is called a scraper. The scraper makes a sound when it moves on the stridulatory file and rubs against the stridulatory file. Each tooth on the stridulatory file is asymmetric in left and right sides, one side of is gentle, and another side is steep. A movement direction of the scraper is opposite to deflection directions of the teeth, which may be called reverse ratchet teeth. Stable self-excited vibration (called chatter in machining) is induced when the scraper scrapes on the reverse ratchet teeth, which is also called scraping vibration. In the scraping vibration, the periodic separation of the scraper and the reverse ratchet teeth effectively reduces frictional force and frictional heat during scraping, thus greatly reducing the wear of the scraper and the reverse ratchet teeth. The male katydids can rub the wings for 50 million to 60 million times in the whole summer.

Based on wear reduction effect in the process of scraping vibration of the scraper and the stridulatory file on the wings of the katydids, the present disclosure provides feature extraction and simplification, and provides an efficient chatter cutting method for a difficult-to-machine material. In this method, a chatter tool bar and a tool are equivalent to the scraper, which is excited to induce stable chatter, thus obtaining a reverse ratchet-shaped surface morphology of the workpiece. Meanwhile, a flank surface of the tool is periodically separated from the surface of the workpiece to make a cutting fluid enter the cutting zone, thus greatly reducing the tool wear, prolonging the tool life, and improving the machining efficiency.

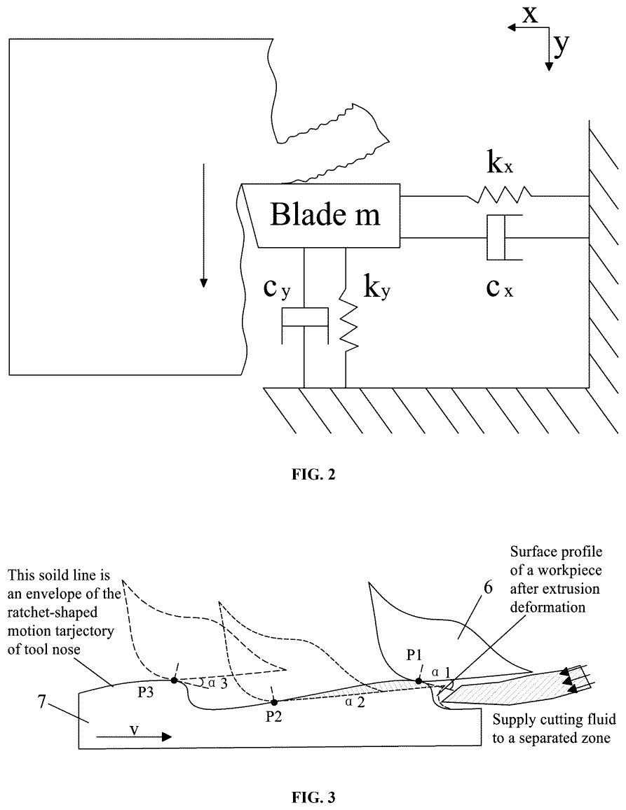

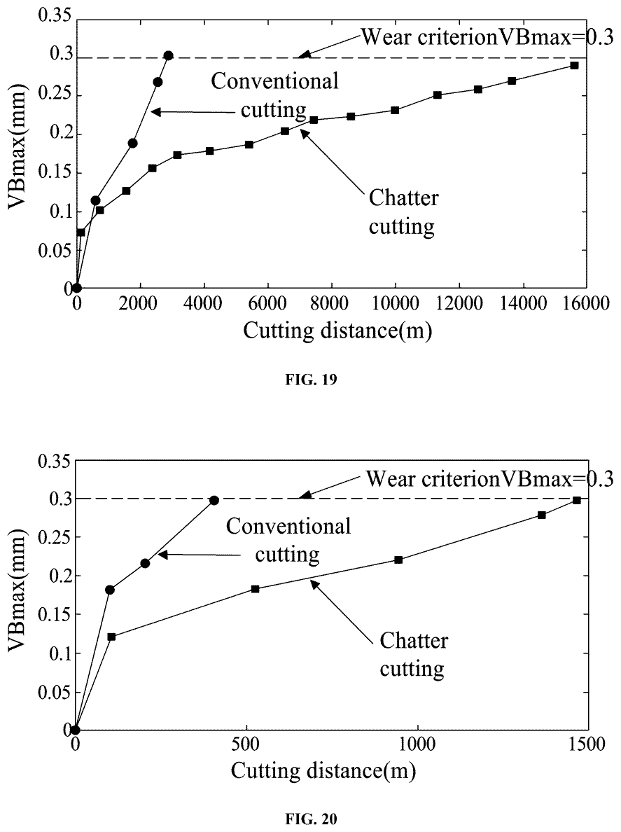

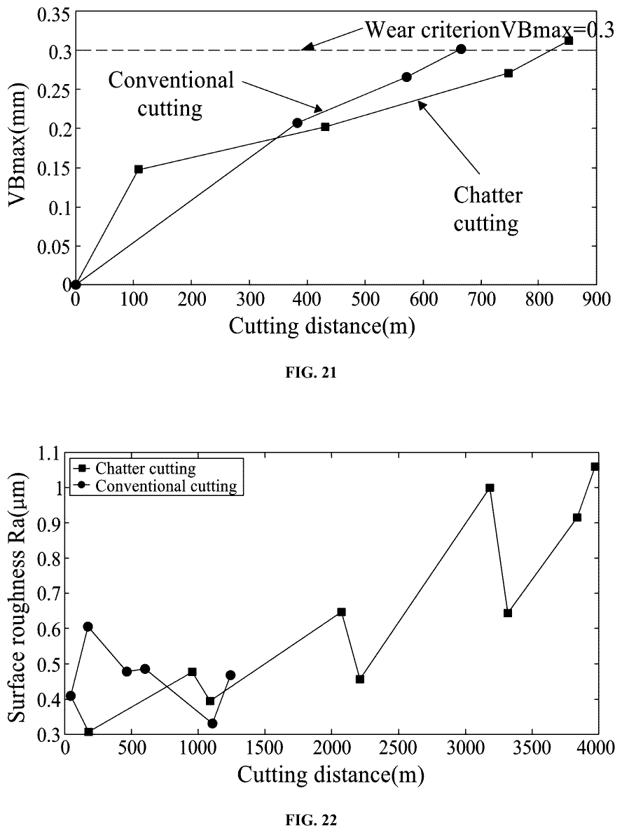

Specifically, as shown in FIG. 2 to FIG. 30, an efficient chatter cutting method for a difficult-to-machine material includes the following steps:

A chatter tool bar is mounted on a machine tool, the machine tool is started, and self-excited chatter is induced through cutting energy of a tool system for chatter cutting. The chatter tool bar can be divided into a turning tool bar, a milling tool bar, a drilling tool bar and the like according to different cutting modes, and different forms of tools are mounted on the chatter tool bar.

During chatter cutting, the chatter tool bar is excited to induce a stable vibration, and a tool forms a ratchet-shaped motion trajectory. It should be noted that a reasonable chatter tool bar can be designed and manufactured according to machining parameters of different difficult-to-machine materials, and the self-excited chatter with dozens of microns amplitude can be induced using the cutting energy of the tool system itself. Compared with the conventional vibration cutting tool bar, the chatter cutting tool bar has the advantages of simple structure, convenient manufacture, no need of external excitation power supply and lower cost. The ratchet-shaped motion trajectory includes the processes that the tool squeezes a surface of a workpiece 7 and the tool is separated from the surface of the workpiece 7, and forming a ratchet-shaped surface morphology on the surface of the workpiece 7.

In the process of separating the tool from the surface of the workpiece 7, the cutting fluid can be controlled to spray to a cutting zone under a certain pressure, and thus the cutting fluid can enter a separated cutting zone for cooling and lubrication, so as to reduce the cutting temperature.

During chatter cutting, a chatter tool bar is excited to induce a stable vibration, a tool forms a ratchet-shaped motion trajectory to periodically squeeze a surface of the workpiece, and is separated from the surface of the workpiece 7. When the tool is separated from the surface of the workpiece 7, a cutting fluid is used to cool and lubricate a separated cutting zone, thus forming a ratchet-shaped surface morphology on the surface of the workpiece 7. The chatter of the chatter tool bar is controlled in a reasonable vibration parameter range, the chatter cutting for the difficult-to-machine material can greatly prolong the tool life compared with conventional cutting, and then the machining efficiency is improved. Meanwhile, the chatter tool bar is simple in structure, convenient to apply and low in price. Therefore, the chatter cutting can become an advanced method for efficient machining of the difficult-to-machine material.

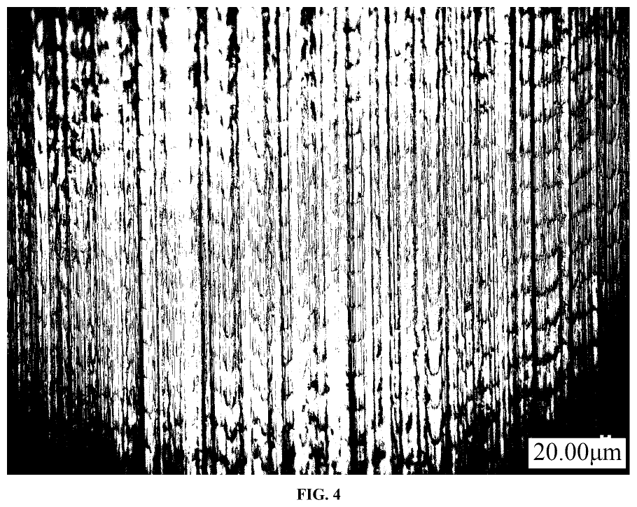

As shown in FIG. 3 and FIG. 4, a chatter cutting process has a large feeding and cutting depth, the chatter cutting process is a continuous cutting process and is different from the discontinuous cutting process of ultrasonic machining. Generation of chatter makes the relative speed, a cutting depth, and a tool angle between the tool and the workpiece 7 are constantly change during machining. As shown in FIG. 3, in a vibration cycle of an envelope of the ratchet-shaped motion trajectory of the tool nose, the cutting tool from point P1 to point P2, a cutting depth gradually increases, a dynamic clearance angle of the cutting tool decreases continuously until a negative clearance angle appears, and a flank surface of the cutting tool continuously squeezes the surface of the workpiece 7, as shown in a shadow area in the figure, the cutting force increases, and the cutting heat is accumulated. P2 is a minimum value of the clearance angle. the cutting tool from point P2 to point P3, the clearance angle of the cutting tool gradually increases, the cutting depth increases first and then decreases, the cutting force increases first and then decreases, a contact area between the flank surface and the workpiece 7 increases first and then decreases rapidly, the flank face of the tool is gradually separated from the surface of the workpiece 7, the cutting fluid begins to enter a flank surface area for cooling and lubrication, and the cutting temperature drops rapidly, thus forming a ratchet-shaped surface morphology as shown in FIG. 4. This is also the reason why the periodic separation of the flank surface after reasonable chatter cutting can greatly improve the tool life. In the whole chatter cutting process, the above process also occurs periodically as the vibration is repeated periodically. It needs to be noted that when the amplitude of a main vibration direction is too large, the acceleration of the tool increases accordingly, the extrusion interference of the flank surface increases, and an impact load during cutting is too large, which leads to a sharp decrease in the tool life. Therefore, a reasonable main vibration amplitude is crucial for prolonging the tool life.

The chatter tool bar needs to be designed and manufactured according to selected machining materials and cutting parameters to ensure that vibration parameters of the chatter tool bar lie within a reasonable range of the vibration parameters. Wherein, the machining materials may be aluminum/magnesium/copper alloy, stainless steel, titanium alloy, superalloy, high-strength steel, and composite materials. The cutting parameters include cutting linear speed, cutting depth, and feed rate. The vibration parameters include main amplitude and main frequency in a main vibration direction of chatter. The reasonable range of the vibration parameters is related to workpiece material, tool material, and cutting parameter, depending on whether the tool life is prolonged or not compared with conventional cutting

On the one hand, in the design and manufacturing process of the chatter tool bar, for the selected machining material and cutting parameters, in order to excite the stable vibration of the chatter tool bar in the cutting process, stiffness of the chatter tool bar is required to be weakened, and a direction in which the stiffness is weakened is perpendicular to a direction of a machined surface or along a direction of a rotation cutting speed, and thus the dynamic change of the cutting force can excite the chatter tool bar to chatter in a weak stiffness direction during cutting. On the other hand, in order to ensure the stable chatter of the chatter tool bar and prevent the chatter from getting out of control the amplitude from too large, the stiffness cannot be too weak. Therefore, the key to the design and manufacture of the chatter tool holder is the control of the stiffness.

A control method for stiffness includes: (1) changing materials of the tool bar, selecting materials with different elastic modulus as materials of the tool bar as required; and (2) changing shape or structure of the tool bar.

As shown in FIG. 2, the ratchet-shaped surface morphology is induced by vibration in one or more directions, and trajectory equation of relative motion between the tool and the workpiece is as follows:

$$X = {A}_{2} sin ( ω t )$$

$$Y = {A}_{1} sin ( ω t + ϕ ) + v t$$

in the equation, X is a displacement perpendicular to the surface of the workpiece 7, Y is a displacement along a direction of cutting speed, A₁ is an amplitude along the direction of cutting speed, A₂ is an amplitude perpendicular to the surface of the workpiece 7, ω is a chatter frequency of the tool in the direction of cutting speed, and ϕ is a phase difference between vibrations in two directions, t is time, and v is cutting linear speed; a trajectory of the relative motion between the tool and the workpiece 7 is obtained with Y as a horizontal axis and X as a vertical axis.

In the chatter cutting process, the amplitudes and frequencies of multiple directions and phase difference of vibration in multiple directions can be measured. During measurement, a triaxial acceleration sensor can be attached to a vibration part of the chatter tool bar for measurement. Based on measurement results, the vibration trajectories of the chatter tool bar and the tool can be determined. A main chatter frequency of the chatter tool bar is approach to an inherent frequency in a main vibration direction (the direction with the maximum amplitude), and an inherent mode of the chatter tool bar is analyzed and designed to regulate the chatter frequency.

When different chatter tool bars are used for chatter cutting, multiple cutting processing technologies can be formed, for example, when combined with a turning method, there may be a chatter turning method; when combined with a milling method, there may be a chatter milling method; when combined with a grinding method, there may be a chatter grinding method; when combined with a drilling method, there may be an axial chatter drilling method; when combined with a reaming method, there may be a chatter reaming method; and when combined with a countersinking method, there may be a chatter countersinking method.

The cutting fluid may be an oil-based cutting fluid, oil-based cutting mist, a water-based cutting fluid, water-based cutting mist or liquid nitrogen, and a cutting fluid pressure is determined according to requirements for machine tool conditions and process effects.

The machine tool may be a lathe, a milling machine, a drilling machine, a grinding machine and a machining center capable of carrying out multiple cutting processes.

According to the solution provided above, the present disclosure provides multiple specific embodiments.

### Embodiment 1: Chatter Cutting of GH4169 Superalloy

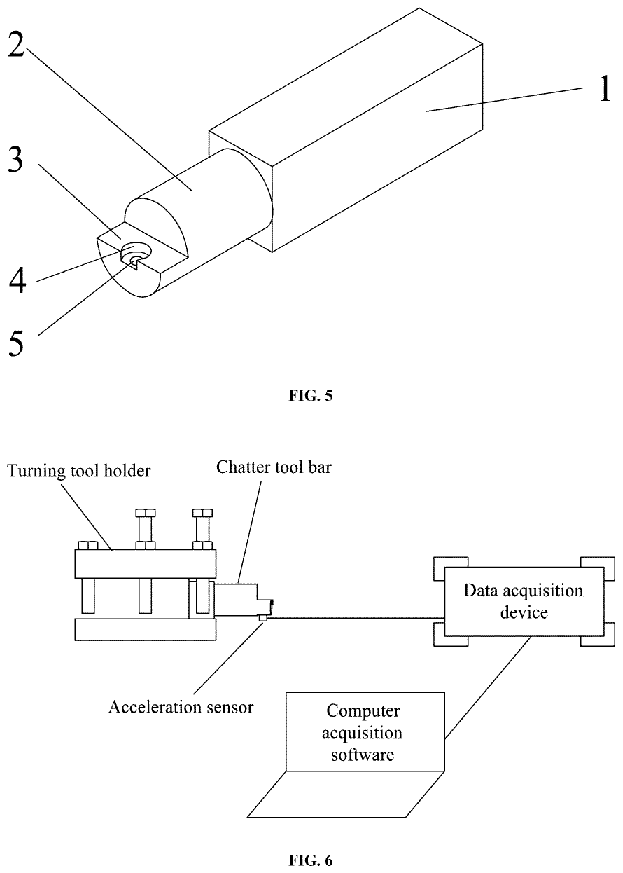

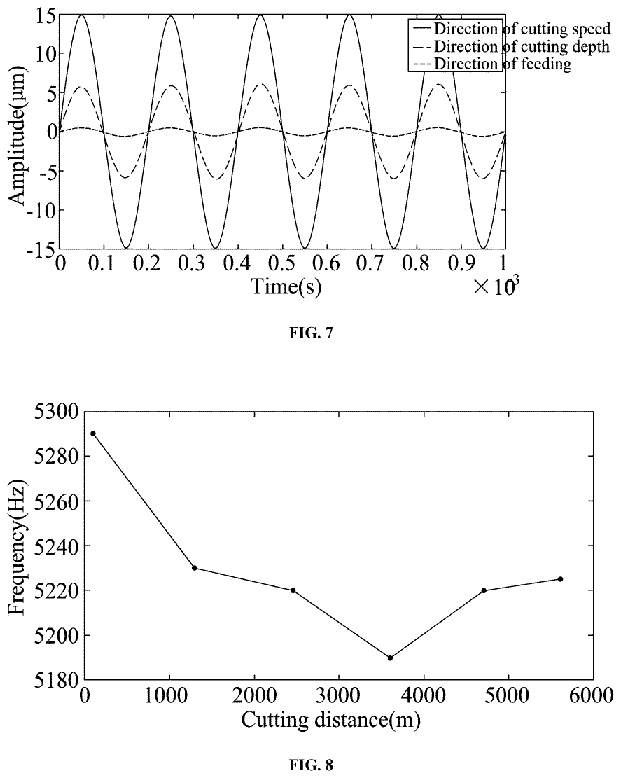

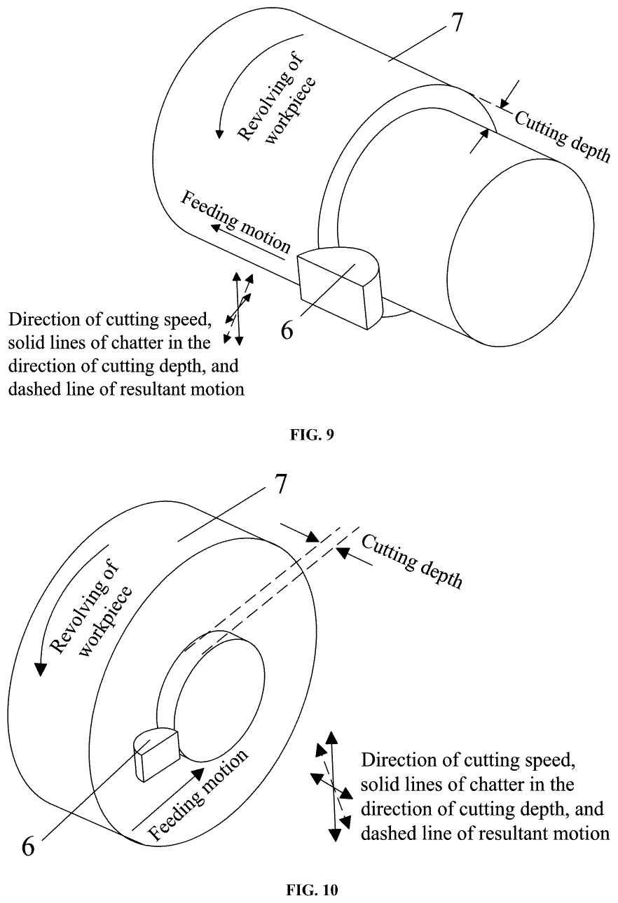

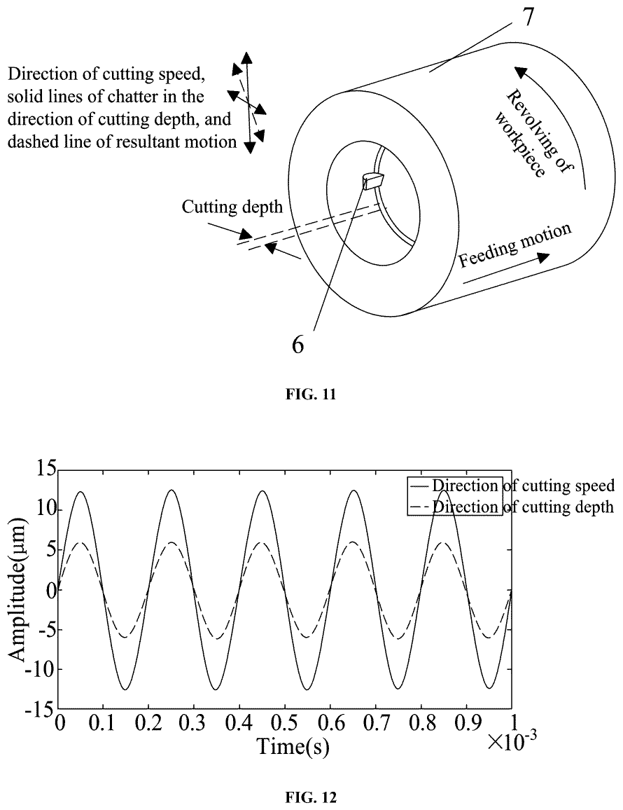

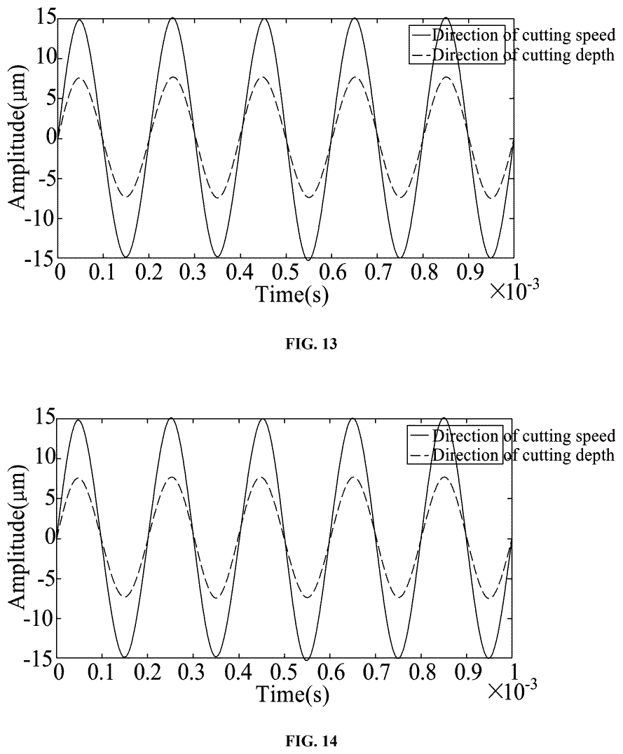

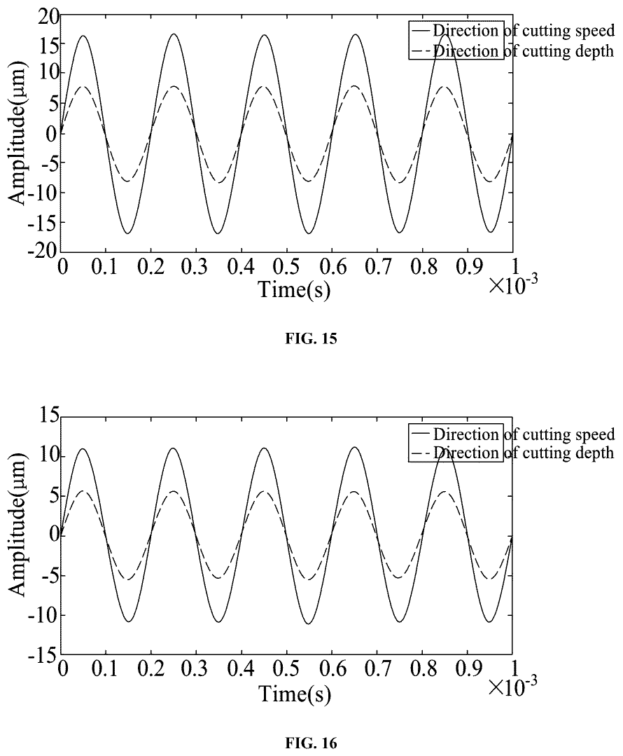

S1. A workpiece 7 is fixed to a lathe, cutting parameters (the tool has cutting linear speed of 30 m/min, a cutting depth of 0.2 mm, and a feed rate of 0.1 mm/r) are selected, and a matched turning chatter tool bar is designed and manufactured for the selected cutting parameters. With the turning as an example, the shape of the tool bar is as shown in FIG. 5, the chatter tool bar is subjected to weak rigidity treatment, and material selection of aluminum alloy 6061. A tool bar structure is divided into a clamping part 1 and an overhanging part 2. The clamping part 1 is in the shape of cuboid, and the overhanging part 2 is in the shape of cylinder. The diameter of the cross section of the overhanging part 2 is 30 mm, a front end of the overhanging part 2 is an installation surface 3 for installing a blade 6, and the installation surface 3 coincides with a central plane of the cylindrical overhanging part 2 and is parallel to the top or bottom surface of the clamping part 1. The center of the front end of the installation surface 3 is provided with a tool groove 4 for installing the blade 6. The width of the installation surface 3 is 13 mm, and the bottom of the tool groove 4 is provided with a threaded hole 5 for fixing the blade 6. The specification of the threaded hole 5 is M4, and the chatter tool bar is clamped on a tool holder. The bottom surface of the clamping part 1 is in contact with the bottom surface of the tool holder, and the top surface of the clamping part is clamped by a tool holder screw. The most important size of the chatter tool bar is the length of the overhanging part 2. Modal parameters of the chatter tool bar can be adjusted by changing the length of the overhanging part 2, and then the vibration parameters such as the amplitude and frequency of the tool bar can be regulated during machining. According to the vibration measurement system shown in FIG. 6, the chatter tool bar is clamped on a turning tool holder, and a triaxial acceleration sensor is fixed to the bottom surface of the front end of the overhanging part 2. Meanwhile, the amplitudes of the chatter tool bar along three directions are simultaneously measured, with measurement results shown in FIG. 7. It is found that the vibration amplitude of the tool bar is stable during the whole machining process when the flank surface of the tool is worn to Vbmax=0.3 mm, and the vibration is mainly divided to along a direction of cutting speed and a cutting depth direction. A vibration amplitude in a feeding direction is tiny, the vibration can be ignored, and the chatter frequency is also relatively stable. As shown in FIG. 8, the chatter frequency in the direction of cutting speed of the tool bar is close to an inherent frequency of first-order bending vibration of the cutter tool bar, and a phase difference between vibrations of the tool bar in both directions is 0°. Therefore, vibration trajectories of three turning modes for turning the workpiece 7 by the blade 6 are shown in FIG. 9 to FIG. 11. The turning mode includes outer circle turning, end face turning and inner hole turning. The cutting parameters (the tool has cutting linear speed of 30 m/min, a cutting depth of 0.2 mm, and a feed rate of 0.1 mm/r) are selected, and a matched turning chatter tool bar is designed and manufactured for the selected cutting parameters. When the turning tool is used to turn outer circle of a workpiece, according to the measurement results shown in FIG. 12, excited vibration directions of the tool bar and the tool are divided to along a direction of cutting speed and a radial cutting depth direction, a main vibration frequency is 5000 Hz, an amplitude of the main vibration direction is 12-13 μm, and a phase difference between vibrations in two directions is 0°. The cutting parameters (the tool has cutting linear speed of 40 m/min, a cutting depth of 0.2 mm, and a feed rate of 0.1 mm/r) are selected, and a matched turning chatter tool bar is designed and manufactured for the selected cutting parameters. When the turning tool is used to turn outer circle of a workpiece, according to the measurement results shown in FIG. 13, excited vibration directions of the tool bar and the tool are divided to along a direction of cutting speed and a radial cutting depth direction, a main vibration frequency is 5000 Hz, an amplitude of the main vibration direction is 14-16 μm, and a phase difference between vibrations in two directions is 0°. The cutting parameters (the tool has cutting linear speed of 45 m/min, a cutting depth of 0.2 mm, and a feed rate of 0.1 mm/r) are selected, and a matched turning chatter tool bar is designed and manufactured for the selected cutting parameters. When the turning tool is used to turn outer circle of a workpiece, according to the measurement results shown in FIG. 14, excited vibration directions of the tool bar and the tool are divided to along a direction of cutting speed and a radial cutting depth direction, a main vibration frequency is 5000 Hz, an amplitude of the main vibration direction is 15-16 μm, and a phase difference between vibrations in two directions is 0°. The cutting parameters (the tool has cutting linear speed of 50 m/min, a cutting depth of 0.2 mm, and a feed rate of 0.1 mm/r) are selected, and a matched turning chatter tool bar is designed and manufactured for the selected cutting parameters. When the turning tool is used to turn outer circle of a workpiece, according to the measurement results shown in FIG. 15, excited vibration directions of the tool bar and the tool are divided to along a direction of cutting speed and a radial cutting depth direction, a main vibration frequency is 5000 Hz, an amplitude of the main vibration direction is 16-18 μm, and a phase difference between vibrations in two directions is 0°. The cutting parameters (the tool has cutting linear speed of 60 m/min, a cutting depth of 0.2 mm, and a feed rate of 0.1 mm/r) are selected, and a matched turning chatter tool bar is designed and manufactured for the selected cutting parameters. When the turning tool is used to turn outer circle of a workpiece, according to the measurement results shown in FIG. 16, excited vibration directions of the tool bar and the tool are divided to along a direction of cutting speed and a radial cutting depth direction, a main vibration frequency is 5800 Hz, an amplitude of the main vibration direction is 10-12 μm, and a phase difference between vibrations in two directions is 0°.

S2. A cutting fluid pressure is set to be 5 bar, the cutting fluid supply is started, and the cutting fluid is sprayed to a separated zone of the flank surface of the chatter cutting.

S3. A turning chatter tool bar is mounted on a corresponding machine tool, and the machine tool is started for chatter cutting.

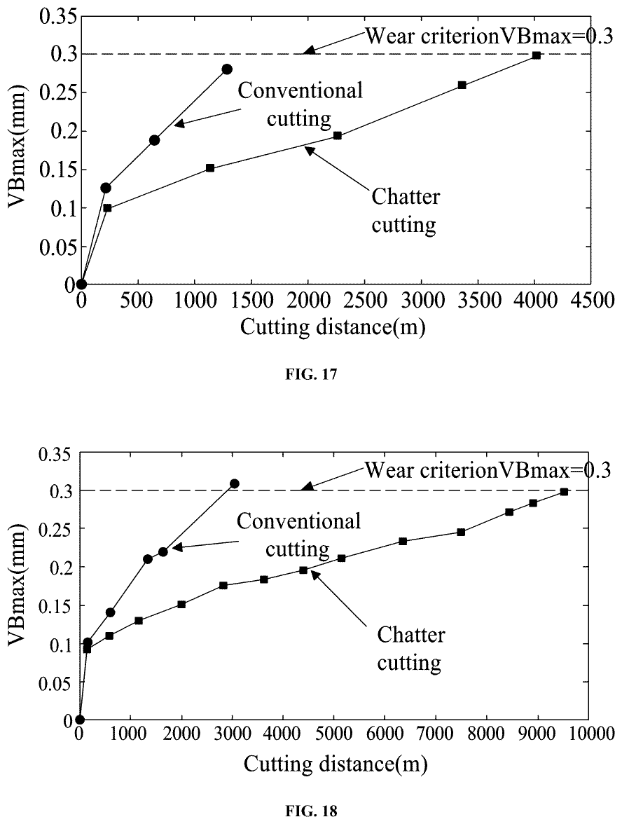

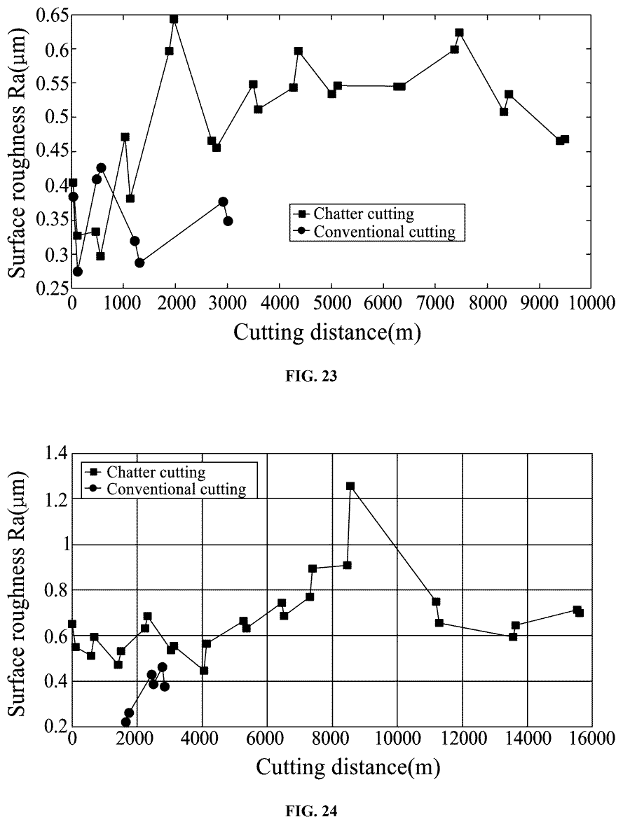

The flank surface of the turning tool is periodically separated from the surface of the workpiece 7, the cutting fluid flows into a cutting core zone for cooling. Under the cutting parameters that the speed is 30 m/min, 40 m/min and 50 m/min, the feed rate is 0.1 mm/r and the cutting depth is 0.2 mm, the service life of a chatter cutting tool is three times that of a conventional cutting tool. Under the cutting parameters that the speed is 45 m/min, the feed rate is 0.1 mm/r and the cutting depth is 0.2 mm, the service life of the chatter cutting tool is five times that of the conventional cutting tool. Under the cutting parameters that the speed is 60 m/min, the feed rate is 0.1 mm/r and the cutting depth is 0.2 mm, although the main vibration parameter of the tool bar is within a reasonable range, the service life of the chatter cutting tool is only increased by 20% compared to the conventional cutting tool, this is because the higher the cutting speed, the faster the cutting heat accumulation, and the cooling effect of flank surface separation is greatly weakened. The life curves of the tool at the speed of 30 m/min, 40 m/min, 45 m/min, 50 m/min and 60 m/min are shown in FIGS. 17, 18, 19, 20 and 21, respectively, there is no significant deterioration the quality of the chatter cutting surface at the same time, and the surface roughness is slightly greater than that of the conventional cutting, which is within a reasonable range, as shown in FIG. 22, FIG. 23 and FIG. 24. Therefore, it is noted that the amplitude of 10-30 μm can effectively prolong the tool life and keep a good surface roughness value below Ra1.6 under this process condition.

### Embodiment 2: Chatter Milling of GH4169 Superalloy

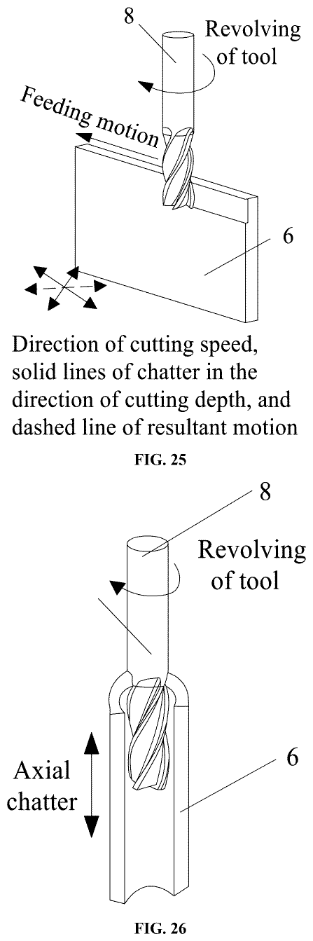

S1. A workpiece 7 is fixed to a milling machine, cutting parameters (the tool has cutting linear speed of 50 m/min, a radial cutting depth of 0.2 mm, an axial cutting depth of 8 mm, and a feed rate of 0.1 mm/r) are selected, and a matched milling chatter tool bar is designed and manufactured for the selected cutting parameters, as shown in FIG. 25 and FIG. 26. When a side edge of the milling tool 8 is used to mill a side surface of the workpiece 7, excited vibration directions of the tool bar and the tool are divided to along a direction of cutting speed and a radial cutting depth direction, the vibration frequency is 5000 Hz, an amplitude in the direction of cutting speed is 12 μm, and the phase difference is 0°. When milling a fillet with a milling tool 8, a vibration direction excited by the tool is along an axial direction, the vibration frequency is 5000 Hz, an amplitude in the axial direction is 12 μm, and the phase difference is 0°.

S2. A cutting fluid pressure is set to be 250 bar, high-pressure cutting fluid supply is started, and the cutting fluid is sprayed to a separated zone of the flank surface of the chatter cutting.

S3. A milling chatter tool bar is mounted on a corresponding machine tool, and the machine tool is started for chatter cutting.

### Embodiment 3: Chatter Grinding of GH4169 Superalloy

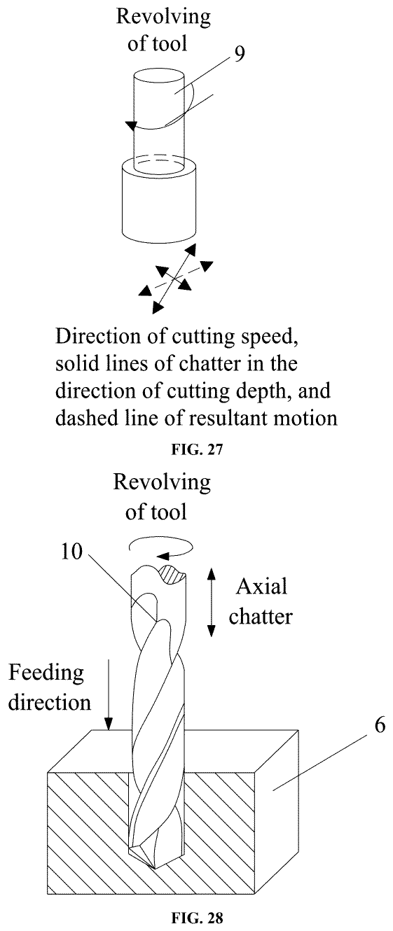

S1. A workpiece 7 is fixed to a grinding machine, cutting parameters (the tool has cutting linear speed of 50 m/min, a radial cutting depth of 0.1 mm, an axial cutting depth of 0.5 mm, and a feed rate of 0.5 mm/r) are selected, and a matched grinding chatter tool bar is designed and manufactured for the selected cutting parameters. As shown in FIG. 27, an excited vibration direction of a grinding head 9 is divided to along a grinding wheel cutting direction and a radial direction, the vibration frequency is 5000 Hz, an amplitude in the cutting direction is 12 μm, and the phase difference is 0°.

S2. A cutting fluid pressure is set to be 250 bar, high-pressure cutting fluid supply is started, and the cutting fluid is sprayed to a separated zone of the flank surface of the chatter cutting.

S3. A grinding chatter tool bar is mounted on a corresponding machine tool, and the machine tool is started for chatter cutting.

### Embodiment 4: Chatter Drilling of GH4169 Superalloy

S1. A workpiece 7 is fixed to a drilling machine, cutting parameters (the tool has cutting linear speed of 50 m/min, and a feed rate of 0.2 mm/r) are selected, and a matched drilling chatter tool bar is designed and manufactured for the selected cutting parameters. As shown in FIG. 28, an excited vibration direction of a drill bit 10 is unique and along an axial direction, the vibration frequency is 5000 Hz, and an amplitude in a direction of cutting speed is 12 μm.

S2. A cutting fluid pressure is set to be 250 bar, high-pressure cutting fluid supply is started, and the cutting fluid is sprayed to a separated zone of the flank surface of the chatter cutting.

S3. A drilling chatter tool bar is mounted on a corresponding machine tool, and the machine tool is started for chatter cutting.

### Embodiment 5: Chatter Reaming of GH4169 Superalloy

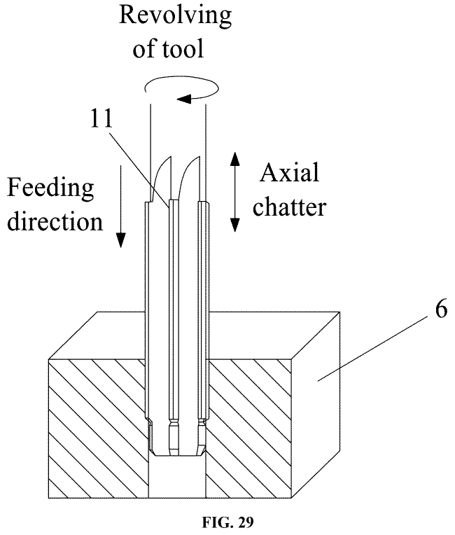

S1. A workpiece 7 is fixed to a reaming machine, cutting parameters (the tool has cutting linear speed of 50 m/min, a feed rate of 0.1 mm/r, and a cutting depth of 0.2 mm) are selected, and a matched reaming chatter tool bar is designed and manufactured for the selected cutting parameters, As shown in FIG. 29, an excited vibration direction of a reaming bar 11 is along an axial direction, the vibration frequency is 5000 Hz, and an amplitude in a direction of cutting speed is 12 μm.

S2. A cutting fluid pressure is set to be 250 bar, high-pressure cutting fluid supply is started, and the cutting fluid is sprayed to a separated zone of the flank surface of the chatter cutting.

S3. A reaming chatter tool bar is mounted on a corresponding machine tool, and the machine tool is started for chatter cutting.

### Embodiment 6: Chatter Countersinking of GH4169 Superalloy

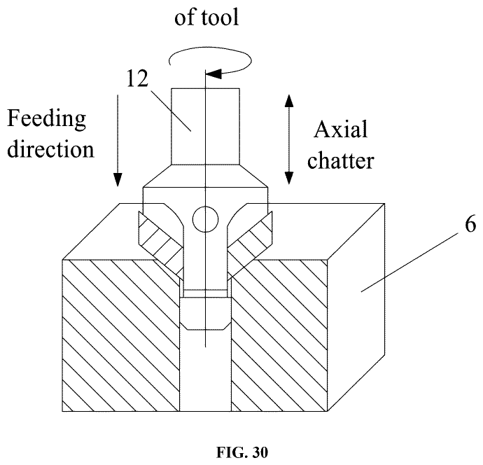

S1. A workpiece 7 is fixed to a countersinking machine, cutting parameters (the tool has cutting linear speed of 50 m/min, and a feed rate of 0.1 mm/r) are selected, and a matched countersinking chatter tool bar is designed and manufactured for the selected cutting parameters. As shown in FIG. 30, an excited vibration direction of a countersinking bit 12 is along an axial direction, the vibration frequency is 5000 Hz, and an amplitude in a direction of cutting speed is 12 μm.

S2. A cutting fluid pressure is set to be 250 bar, high-pressure cutting fluid supply is started, and the cutting fluid is sprayed to a separated zone of the flank surface of the chatter cutting.

S3. A countersinking chatter tool bar is mounted on a corresponding machine tool, and the machine tool is started for chatter cutting.

Specific examples are used herein for illustration of the principles and implementation methods of the present disclosure. The description of the embodiments is merely used to help illustrate the method and its core principles of the present disclosure. Meanwhile, a person of ordinary skill in the art can make multiple modifications in terms of specific embodiments and scope of application in accordance with the teachings of the present disclosure. In conclusion, the content of this specification shall not be construed as a limitation to the present disclosure.

What is claimed is:

1. An efficient chatter cutting method for a difficult-to-machine material, comprising the following steps:
installing a chatter tool bar on a machine tool, starting the machine tool, and inducing self-excited chatter for chatter cutting through cutting energy of a tool system;
during chatter cutting, exciting the chatter tool bar to induce stable vibration, making the tool form a ratchet-shaped motion trajectory, the ratchet-shaped motion trajectory includes processes that the tool is pressed on a surface of a workpiece and the tool is separated from the surface of the workpiece, and forming a ratchet-shaped surface morphology on the surface of the workpiece; and
during separation of the tool from the surface of the workpiece, enabling a cutting fluid to enter a separated cutting zone for cooling and lubrication, and reducing cutting temperature.

2. The efficient chatter cutting method for a difficult-to-machine material according to claim 1, wherein a process in one vibration cycle of the ratchet-shaped motion trajectory comprise the following: cutting depth is gradually increased, dynamic clearance angle is continuously decreased until the clearance angle is negative, a flank surface is continuously pressed on the surface of the workpiece, cutting force is increased, and cutting heat is accumulated; clearance angle of the tool is gradually increased, the cutting depth is increased and then decreased, the cutting force is increased and then decreased, contact area between the flank surface and the workpiece is increased and then decreased rapidly, the flank surface of the tool is gradually separated from the surface of the workpiece, the cutting fluid is sprayed into the separated cutting zone from the flank surface of the tool, and the cutting temperature is decreased rapidly.

3. The efficient chatter cutting method for a difficult-to-machine material according to claim 1, wherein the chatter tool bar is designed and manufactured according to selected machining materials and cutting parameters to ensure that vibration parameters of the chatter tool bar lie within a reasonable range of vibration parameters; the machining materials comprise aluminum/magnesium/copper alloy, stainless steel, titanium alloy, superalloy, high-strength steel, and composite materials; the cutting parameters comprise cutting linear speed, the cutting depth and feed rate; the vibration parameters comprise a main amplitude and a main frequency in a main vibration direction of chatter; and the reasonable range of vibration parameters is related to workpiece material, tool material and cutting parameter, depending on whether the tool life is prolonged or not compared with conventional cutting.

4. The efficient chatter cutting method for a difficult-to-machine material according to claim 2, wherein the chatter tool bar is designed and manufactured according to selected machining materials and cutting parameters to ensure that vibration parameters of the chatter tool bar lie within a reasonable range of vibration parameters; the machining materials comprise aluminum/magnesium/copper alloy, stainless steel, titanium alloy, superalloy, high-strength steel, and composite materials; the cutting parameters comprise cutting linear speed, the cutting depth and feed rate; the vibration parameters comprise a main amplitude and a main frequency in a main vibration direction of chatter; and the reasonable range of vibration parameters is related to workpiece material, tool material and cutting parameter, depending on whether the tool life is prolonged or not compared with conventional cutting.

5. The efficient chatter cutting method for a difficult-to-machine material according to claim 3, wherein stiffness of the chatter tool bar is required to be weakened, and a direction in which the stiffness is weakened is perpendicular to a direction of a machined surface or along a direction of a rotation cutting speed; and during the cutting, dynamic changes in the cutting force excite the chatter tool bar to chatter along a direction in which the stiffness is weak, and meanwhile, the stiffness is unable to be too weak, depending on whether the tool life is prolonged or not compared with conventional cutting.

6. The efficient chatter cutting method for a difficult-to-machine material according to claim 4, wherein stiffness of the chatter tool bar is required to be weakened, and a direction in which the stiffness is weakened is perpendicular to a direction of a machined surface or along a direction of a rotation cutting speed; and during the cutting, dynamic changes in the cutting force excite the chatter tool bar to chatter along a direction in which the stiffness is weak, and meanwhile, the stiffness is unable to be too weak, depending on whether the tool life is prolonged or not compared with conventional cutting.

7. The efficient chatter cutting method for a difficult-to-machine material according to claim 5, wherein a control method for stiffness comprises changing materials of the tool bar, selecting materials with different elastic modulus as materials of the tool bar as required; and changing the shape or structure of the tool bar, depending on whether the tool life is prolonged or not compared with conventional cutting.

8. The efficient chatter cutting method for a difficult-to-machine material according to claim 6, wherein a control method for stiffness comprises changing materials of the tool bar, selecting materials with different elastic modulus as materials of the tool bar as required; and changing the shape or structure of the tool bar, depending on whether the tool life is prolonged or not compared with conventional cutting.

9. The efficient chatter cutting method for a difficult-to-machine material according to claim 1, wherein the ratchet-shaped surface morphology is induced by vibration in one or more directions, and trajectory equation of relative motion between the tool and the workpiece is as follows:
$$X = {A}_{2} sin ( ω t )$$
$$Y = {A}_{1} sin ( ω t + ϕ ) + v t$$
in the equation, X is a displacement perpendicular to the surface of the workpiece, Y is a displacement along a direction of cutting speed, A₁ is an amplitude along the direction of cutting speed, A₂ is an amplitude perpendicular to the surface of the workpiece, ω is a chatter frequency of the tool in the direction of cutting speed, and ϕ is phase difference between vibrations in two directions, t is time, and v is cutting linear speed; a trajectory of the relative motion between the tool and the workpiece is obtained with Y as a horizontal axis and X as a vertical axis.

10. The efficient chatter cutting method for a difficult-to-machine material according to claim 1, wherein a triaxial acceleration sensor is attached to a vibration part of the chatter tool bar to measure amplitudes and frequencies in multiple directions and phase difference between vibrations in multiple directions, so as to determine a vibration trajectory of the chatter tool bar and the tool; a main chatter frequency of the chatter tool bar is approaching to an inherent frequency in the main vibration direction, and an inherent mode of the chatter tool bar is analyzed and designed to regulate the chatter frequency.

11. The efficient chatter cutting method for a difficult-to-machine material according to claim 1, wherein the chatter cutting comprises a chatter turning method, a chatter milling method, a chatter grinding method, a chatter drilling method, a chatter reaming method and a chatter countersinking method.

12. The efficient chatter cutting method for a difficult-to-machine material according to claim 1, wherein the cutting fluid is oil-based cutting fluid, oil-based cutting mist, a water-based cutting fluid, water-based cutting mist, or liquid nitrogen, and cutting fluid pressure is determined according to requirements for machine tool conditions and process effects.

13. The efficient chatter cutting method for a difficult-to-machine material according to claim 1, wherein the machine tool comprises a lathe, a milling machine, a drilling machine, a grinding machine, and a machining center capable of carrying out cutting processes.
